(19) United States
(12) Patent Application Publication
(10) Pub. No.: US 2018/0255748 A1
(43) Pub. Date: Sep. 13, 2018

(54) Solitary Bee Nesting Shelter

(71) Applicant: Candy Lee Vanderhoff, San Diego, CA (US)

(72) Inventor: Candy Lee Vanderhoff, San Diego, CA (US)

(21) Appl. No.: 15/452,715

(22) Filed: Mar. 7, 2017

(51) Int. Cl. A01K 47/06; A01K 49/00

(52) U.S. Cl. CPC A01K 47/06; A01K 49/00

(57) ABSTRACT

The said invention, a solitary bee nesting shelter configured of a main housing and removable nest block inserts with a plurality of elongated cavities. Said cavities on the vertical face of the combined frame and insert blocks to be laid out in a series of geometrical shapes including spirals. Said invention upper surface comprised of a resilient material with one iteration comprised of a solar powered path light. The said invention shall have fasteners for installation, one iteration is a hook on the back, and another is a removable stake in the bottom.

### BACKGROUND OF THE INVENTION

Solitary bees pollinate fruits and vegetables and are desirable for farmers and gardeners. Managing the nest block inserts will decrease bees nesting in previously inhabited cavities that may harbor pest, such as mites.

Clean nesting sites will increase bee population and therefore, increase pollination and crop yields.

Pesticides used in areas where bees are nesting are toxic to them, by providing a pesticide-free nesting block the bee population will stand a better chance of survival.

Bee nesting sites are in decline due to development, the said invention provides additional nest site for bees, especially in urban areas and in developed farm sites.

After bees nest in a tunnel it becomes infested with other biological life that may be dangerous to bees. By providing clean nest blocks after one use the spread of disease is mitigated.

The geometrical design of the apertures provides a returning bee a visual cue to find their nest site.

### SUMMARY

In one embodiment of the invention the housing is wood fastened with nails and glue. The replaceable inserts are not secured and will easily slide in and out of the housing. A stop is placed on the backside of the housing to prevent insert blocks from continuing through the opposite side.

In one embodiment of the invention several apertures extend from the face and into 90% of the aperture. The apertures do not extend out the backside of the nest block. The apertures vary in sizes from 0.25-inch to 0.75-inch.

In one embodiment of the present invention the apertures layout on the vertical face of the housing and nest blocks shall have a minimum of 0.25-inch between apertures. Spacing and layout provide an identifiable pattern for bees to find their nest.

In one embodiment of the present invention the nesting blocks are removable and replaceable from the housing, so that a used block can be discarded and a new, clean block can be inserted into the shelter's housing.

In one embodiment of the present invention the roof is a solar powered light.

In one embodiment of the present invention the nesting tunnels are laid out in a unique design, so that a returning bee can easily recognize the pattern and find the tunnel where it is nesting.

### DESCRIPTION OF THE RELATED ART

Solitary bee shelters are made from bundles of paper tubes and bamboo stalks.

Said bundles have little space between tunnels and do not provide any distinguishable pattern for the bees to identify as they return to their nesting tunnel.

Existing fabricated shelters may have disease, mites or debris in a tunnel if not discarded after one use.

### BRIEF DESCRIPTION OF THE DRAWINGS

FIG. 1 is a perspective view of the present invention showing the nesting block in the main frame of the shelter.

FIG. 2 is a partial exploded view of the invention showing the nesting block removed from their housing.

FIG. 3 is a perspective view of the invention in a smaller version, which has one removable nesting block inset.

FIG. 4 is a perspective view of the invention in a smaller version, which has one removable nesting block showing the inset removed.

FIG. 5 is a back view of the invention in a smaller version showing the metal hook that allows the shelter to be hung from a vertical surface.

FIG. 6 is a single wood nest block insert that shows a detail of the drilled out aperture.

### DESCRIPTION OF THE DRAWINGS

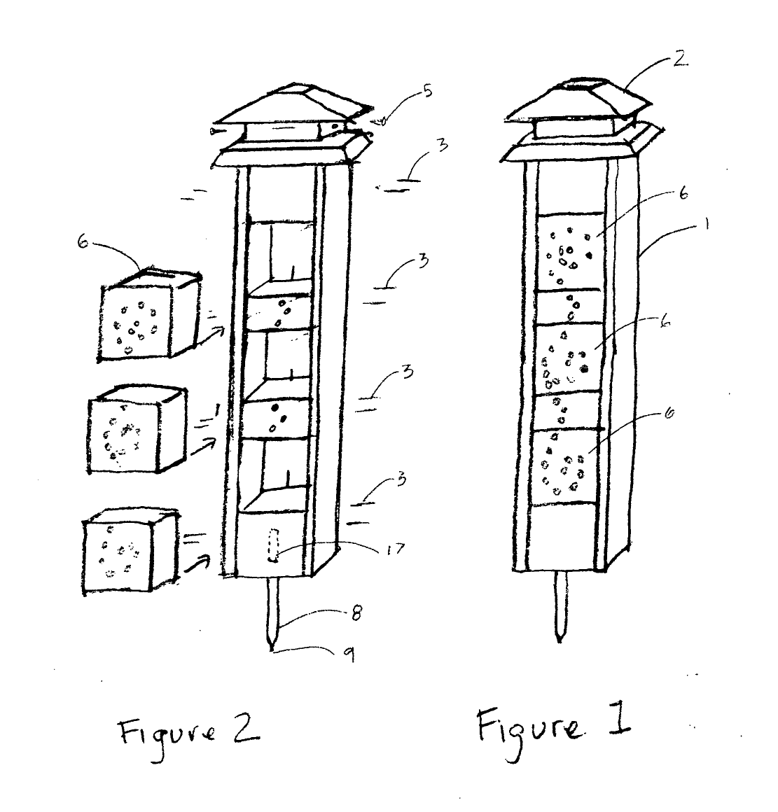

In FIG. 1, one sees a perspective view of the shelter housing 1, as it will sit on level ground in the landscape with the removable inserts 6 in the permanent resting place. A solar powered light 2 is on the top of the shelter to provide light at night. The pre-manufactured light unit also acts as a roof and provides protection from the elements.

In FIG. 2, a partial exploded view shows the micro nails 3 used along with glue to hold the housing elements together. The solar powered light is attached to a hidden wood block 4 with two screws 5.

In FIG. 2 one sees the nesting block inserts slid out of the shelter housing 6. The bottom of the shelter has an aperture 7 drilled out to accommodate a stake 8 that has one pointed end 9 to be inserted into the earth.

In FIG. 3 one sees a smaller version of the shelter with a housing and single nesting block insert 10. The shelter has a pre-fabricated hip roof 11 over a hidden wood block 12. The main frame of the shelter is made up of four side panels 13, a slightly larger top panel 14, a hidden wood block 12 and a waterproof hip roof piece 11.

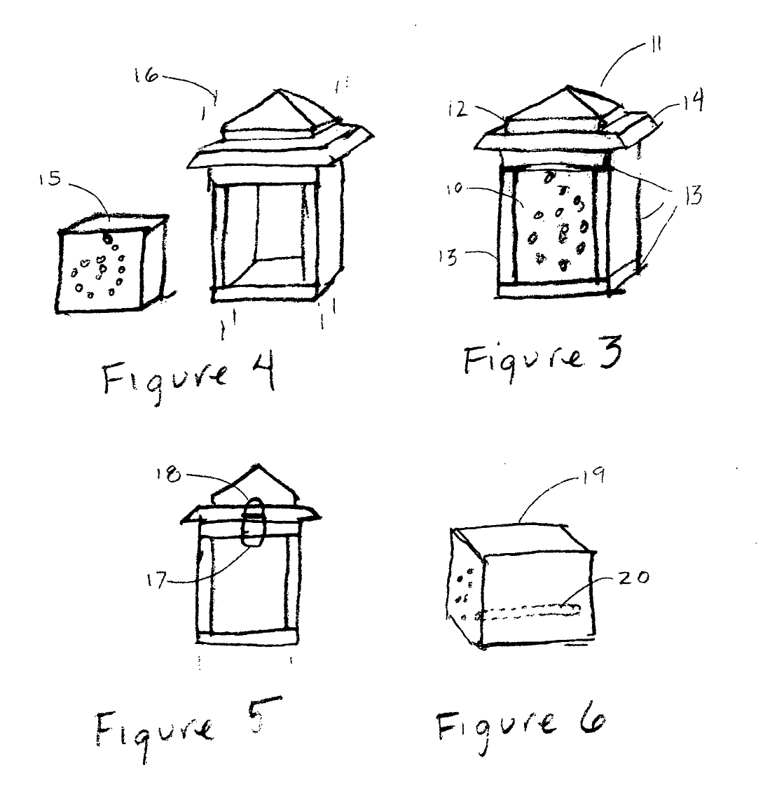

In FIG. 4, the single nesting block insert is removed 15.

In FIG. 4, the nails 16 are shown as an exploded view where they will be inserted through the wood panel.

In FIG. 5, one sees the back view of the small shelter. The backside shows how a metal hook is attached to the top panel 18 so the shelter can be hung on a vertical surface. The hook extends to the cavity area where is will act as a stop for the insert block 17. The end of the hook assembly extends into the nest block area to provide a stop for the block.

In FIG. 6, a section of a single, nesting block 19 is shown with a view of the Aperture 20.

What is claimed is:

1. A structure for repose for at least one solitary bee comprising a;
Housing; and
a plurality of elongated cavities disposed within and supported by said housing, each cavity comprised of an opening and oppositely blind end;
said plurality of elongated cavities being arranged in a selected pattern comprised of a selected arrangement comprised of a selected diameter, wherein at least two said cavities comprised of different aperture diameters.
A) The structure of claim 1, wherein said selected pattern is a spiral or other geometrical patterns.
B) The structure of claim 1, wherein selected diameter of elongated cavities is between 0.125-inch to 0.75-inch.
C) Said shelter to have various aperture depths ranging from 3-inches to 6-inches.
D) The structure of claim 1, wherein selected housing is comprised of a resilient material.

2. A system where a housing for the shelter of solitary bees, comprises;
A) The system of claim 2, a housing comprised of two sides, two or more attached cross members and one or more voids where disposable elements with elongated cavities are placed.
B) The system of claim 2, said housing void compartments to comprise an open side and a side with a stop.
C) The system of claim 2, said shelter comprised of resilient materials.
D) The system of claim 2, said shelter bottom surface comprised of one aperture to accommodate a stake.
E) The system of claim 2, said shelter back comprised of a hook and a stop.
F) The system of claim 2, said shelter rooftop comprised of a resilient material, in one configuration a pre-manufactured solar powered light.
G) The system of claim 2, said shelter elongated cavities to be arranged in a pattern with minimum of 0.25 inches between cavities.
H) The system of claim 2, wherein said element slides into said housing void and new element replaces the other.
I) The system of claim 2, wherein said element remains in place by gravitational pull.
J) The system of claim 2, wherein said element meets a stop once inside said housing void.

3. A method where an element comprised of elongated cavities are arranged in geometrical design.
A) A method of claim 3, wherein said pattern is arranged so as to allow bee to return to return to the cavity she is nesting in.
B) A method of claim 3, wherein said cavities are varies so as to attract various bees in various regions.
C) A method of claim 3, wherein said cavities are a smooth and clean.
